(19) United States
(12) Patent Application Publication
(10) Pub. No.: US 2023/0288915 A1
(43) Pub. Date: Sep. 14, 2023

(54) INFORMATION PROCESSING DEVICE, INFORMATION PROCESSING METHOD, AND COMPUTER PROGRAM PRODUCT

(71) Applicant: KABUSHIKI KAISHA TOSHIBA, Tokyo (JP)

(72) Inventors: Gen LI, Ota (JP); Masaaki TAKADA, Abiko (JP); Myungsook KO, Tokyo (JP)

(73) Assignee: KABUSHIKI KAISHA TOSHIBA, Tokyo (JP)

(21) Appl. No.: 17/821,607

(22) Filed: Aug. 23, 2022

(30) Foreign Application Priority Data
Mar. 9, 2022 (JP) 2022-036391

(51) Int. Cl. G05B 19/4155

(52) U.S. Cl. CPC G05B 19/4155; G05B 2219/45031

(57) ABSTRACT

According to an embodiment, an information processing device includes one or more processors. The processors calculate a first degree of influence of a plurality of variables on output data, and a frequency at which the plurality of variables are selected as a variable influencing the output data, based on K first models. The K first models are models estimated using a plurality of pieces of input data including the plurality of variables. The plurality of input data are obtained in K periods. K is an integer of 2 or more. The first model receives input of the input data including the plurality of variables and outputs the output data. The processors output the first degree of influence and the frequency in association with each other.

### CROSS-REFERENCE TO RELATED APPLICATIONS

This application is based upon and claims the benefit of priority from Japanese Patent Application No. 2022-036391, filed on Mar. 9, 2022; the entire contents of which are incorporated herein by reference.

### FIELD

Embodiments described herein relate generally to an information processing device, an information processing method, and a computer program product.

### BACKGROUND

For example, a semiconductor factory and a chemical plant mass-produces various types of products, and can acquire a large amount of data from a sensor and the like installed in each manufacturing process. In addition, by analyzing accumulated data, it is possible to take countermeasures to suppress variations in quality characteristics. For example, various efforts are made every day to improve productivity and yield based on analysis results. One of frequently used countermeasures is regression analysis using statistics and machine learning. By using data such as sensor values, setting values, and the device information as an explanatory variable of the regression model and using the quality characteristic as an objective variable, it is possible to analyze the cause of variation in the quality characteristics.

The factor analysis using the regression model utilizes a model with high interpretability, such as a linear model, a decision tree, and an additive model. By calculating, for each explanatory variable, an index representing the degree of influence on the output data (objective variable) of the model, such as a regression coefficient and the degree of importance, and by using the calculated index, it is possible to identify a factor (explanatory variable) that can explain the variation in quality characteristics.

### BRIEF DESCRIPTION OF THE DRAWINGS

FIG. 1 is a block diagram of an information processing system according to a first embodiment;

FIG. 2 is a flowchart of estimation processing and visualization processing;

FIG. 3 is a diagram illustrating an example of a matrix diagram;

FIG. 4 is a diagram illustrating an example of a matrix diagram;

FIG. 5 is a block diagram of an information processing system according to a second embodiment;

FIG. 6 is a diagram illustrating an example of a matrix diagram;

FIG. 7 is a diagram illustrating an example of a matrix diagram;

FIG. 8 is a block diagram of an information processing system according to a third embodiment;

FIG. 9 is a block diagram of an information processing system according to a fourth embodiment;

FIG. 10 is a diagram illustrating an example of a matrix diagram;

FIG. 11 is a diagram illustrating an example of a matrix diagram; and

FIG. 12 is a hardware configuration diagram of the information processing device according to the embodiments.

### DETAILED DESCRIPTION

Preferred embodiments of an information processing device according to the present invention are described below in detail with reference to the accompanying drawings.

According to an embodiment, an information processing device includes one or more processors. The processors calculate a first degree of influence of a plurality of variables on output data, and a frequency at which the plurality of variables are selected as a variable influencing the output data, based on K first models. The K first models are models estimated using a plurality of pieces of input data including the plurality of variables. The plurality of input data are obtained in K periods. K is an integer of 2 or more. The first model receives input of the input data including the plurality of variables and outputs the output data. The processors output the first degree of influence and the frequency in association with each other.

As described above, by using the index representing the degree of influence of each explanatory variable on the output data of the model, it is possible to identify the factor (explanatory variable) that can explain the variation in the quality characteristics. However, when there are a large number of explanatory variables, it is practically incapable of analyzing all the variables one by one, making it necessary to narrow down the explanatory variables to be checked. One method is to utilize a penalized regression model. This makes it possible to estimate (build) a regression model including a small number of important explanatory variables. As another method, there is also a method of estimating a model including a designated number of explanatory variables by sequentially adding, to the model, an explanatory variable having high correlation with an objective variable or an explanatory variable that can improve the accuracy of the model. Conversely, it is also possible to sequentially remove explanatory variables until the number reaches the designated number.

There are many explanatory variables in data in semiconductor factories, chemical plants, and the like, and trends often change from moment to moment. In order to constantly grasp the latest trend, it is required to perform periodic model update using the latest data. At this time, when using the latest data alone, the number of pieces of data is relatively small, and therefore the influence of noise appears strongly, which may make it difficult to identify the factor. Therefore, in order to perform factor analysis with higher accuracy, it is necessary to grasp not only the latest trend but also trends in medium to long terms. That is, it is necessary to perform integrated analysis including a model estimated in the past.

Integrated evaluation often uses ranking using a mean of the degree of influence of each explanatory variable. The explanatory variable ranked high is determined as an important factor. The mean of the degree of influence is calculated by the following two methods, for example.

(M1) A method of calculating a mean of the degree of influence in an entire period.

(M2) A method of using the degree of influence of an explanatory variable for calculation of the mean only in a period in which the explanatory variable is selected as a variable that influences output of a model. For example, when a penalized regression model is used, only some explanatory variables are selected by the model in each period. For each explanatory variable, the degree of influence of the explanatory variable is used for calculation of the mean only in the period selected for the model.

Each of the above two methods has drawbacks as follows.

(M1): In a case where there is an explanatory variable that has temporarily had a strong influence due to a sudden failure or the like, the degree of influence of this explanatory variable becomes zero in many sections of the period, leading to a small mean. As a result, this is less likely to rank high even though the degree of urgency is high.

(M2): An explanatory variable that has temporarily had a strong influence is overestimated, whereas an explanatory variable that constantly has an influence but has a small value of the degree of influence is relatively underestimated. Such an explanatory variable is less likely to rank high despite having an influence stably.

In this manner, there is a possibility of occurrence of overlooking of a factor in individual cases of ranking performed using the mean of the degree of influence calculated by any method.

In addition to the above two methods, for example, there is also a method of performing integrated evaluation from the frequency of the period in which the degree of influence is equal to or greater than a threshold. However, this method identifies only an explanatory variable having a high degree of influence and a high frequency as a factor, leading to overlooking of the factor.

Therefore, the information processing device according to each of the following embodiments calculates, for each explanatory variable, the degree of influence in the period selected as a variable influencing the output data and the frequency of selection (hereinafter, referred to as selection frequency), and then displays the calculated degree of influence and the selection frequency in association with each other. For example, the explanatory variables can be displayed as being classified into the following four categories. The user can extract and identify appropriate factors without fail with reference to the characteristics of each category. That is, it is possible to further easily identify the influence of the plurality of variables on the output.

(C1) Variable having a high degree of influence and a high selection frequency: a variable having a high influence stably.

(C2) Variable having a high degree of influence but a low selection frequency: variable having a high degree of suddenness due to temporary influence.

(C3) Variable with low degree of influence but high selection frequency: variable with low degree of influence but steady influence.

(C4) Variable having a low degree of influence and a low selection frequency: a variable that can be excluded from factor candidates.

### First Embodiment

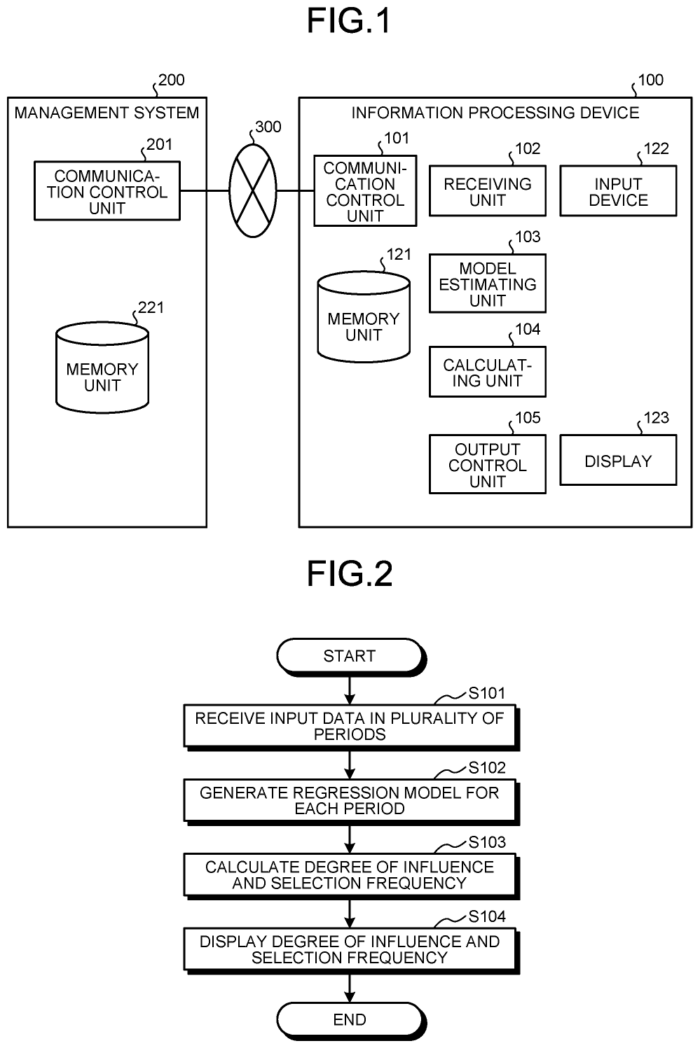

FIG. 1 is a block diagram illustrating an exemplary configuration of an information processing system that includes the information processing device according to the present embodiment. As illustrated in FIG. 1, in the information processing system; an information processing device 100 and a management system 200 are connected to each other via a network 300.

The information processing device 100 as well as the management system 200 can be configured as, for example, a server device. The information processing device 100 and the management system 200 can be implemented as a plurality of physically-independent devices (systems). Alternatively, the functions of the information processing device 100 and the management system 200 can be provided in a single physical device. In the latter case, the network 300 need not be included. Still alternatively, at least either the information processing device 100 or the management system 200 can be built in a cloud environment.

The network 300 is, for example, a local area network (LAN) or the Internet. Moreover, the network 300 either can be a wired network or can be a wireless network. Meanwhile, instead of involving the network 300, the information processing device 100 and the management system 200 can send and receive data using a direct wired connection or a direct wireless connection established among the components.

The management system 200 is a system for managing the models processed by the information processing device 100, and for managing the data used in the learning (estimation) and the analysis of models. The management system 200 includes a memory unit 221 and a communication control unit 201.

The memory unit 221 is used to store a variety of information used in various processes performed in the management system 200. For example, the memory unit 221 is used to store the input data to be used in the estimation of models. The memory unit 221 can be configured using any commonly-used memory medium such as flash memory, a memory card, random access memory (RAM), a hard disk drive (HDD), or an optical disk.

A model receives explanatory variables as input, and outputs the inference about the objective variables. Examples of a model include a linear regression model, a polynomial regression model, a logistic regression model, a Poisson regression model, a generalized liner model, a generalized additive model, a decision tree, and a neural network model. However, a model is not limited to those examples, and any model can be used as long it is expressed using parameters.

A model is estimated as a result of performing learning with the use of input data that contains objective variables and explanatory variables. The objective variables represent, for example, information indicating the quality characteristics, the percent defective, and the non-defective items/defective items. The explanatory variables represent other sensor values, setting values such as processing conditions, and control values.

The communication control unit 201 controls the communication performed with external devices such as the information processing device 100. For example, the communication control unit 201 sends the input data to the information processing device 100.

The constituent element explained above (the communication control unit 201) is implemented using, for example, one or more hardware processors. For example, the constituent element explained above can be implemented by making a processor such as a central processing unit (CPU) execute a computer program, that is, can be implemented using software. Alternatively, the constituent element explained above can be implemented using a dedicated processor such as an integrated circuit (IC), that is, can be implemented using hardware Still alternatively, the constituent elements explained above can be implemented using a combination of software and hardware In the case of using a plurality of processors, each processor either can implement one of the constituent elements or can implement two or more constituent elements.

The information processing device 100 includes a memory unit 121, an input device 122, a display 123, a communication control unit 101, a receiving unit 102, a model estimating unit 103, a calculating unit 104, and an output control unit 105.

The memory unit 121 stores a variety of information used in various processes performed in the information processing device 100. For example, the memory unit 121 stores the information (such as input data) obtained from the management system 200 via the communication control unit 101 and the receiving unit 102, the parameters of the models estimated by the model estimating unit 103, information calculated by the calculating unit 104, and the like. The memory unit 121 can be configured using any commonly-used memory medium such as flash memory, a memory card, RAM, an HDD, or an optical disk.

The input device 122 is a device for enabling the user to input information. Examples of the input device 122 include a keyboard and a mouse. The display 123 represents an example of an output device for outputting information. Examples of the display 123 include a liquid crystal display. The input device 122 and the display 123 can be integrated as a touch-sensitive panel.

The communication control unit 101 controls the communication performed with external devices such as the management system 200. For example, the communication control unit 101 receives the input data from the management system 200.

The receiving unit 102 receives input of a variety of information. For example, the receiving unit 102 receives a plurality of pieces of input data from the management system 200 via the communication control units 201 and 101. The plurality of pieces of input data represents, for example, a plurality of pieces of data obtained in K (K is an integer of 2 or more) periods (data periods) different from each other. In addition, each of the plurality of input data includes at least a plurality of variables (explanatory variables) to be inputs to the model.

The K periods may be set in advance, or a value specified by the user may be used. Alternatively, the periods can be decided based on the degree of accuracy of the model estimated by the model estimating unit 103.

The receiving unit 102 requests, for example, the management system 200 for data transmission performed during the designated (decided) period, and receives the input data sent from the management system 200 in response to the request. Herein, the configuration can be such that the receiving unit 102 or the model estimating unit 103 can extract the input data corresponding to the designated period, from among a plurality of pieces of input data received from the management system 200.

The model estimating unit 103 estimates a plurality of models using a plurality of pieces of input data. For example, for each of the K periods, the model estimating unit 103 uses a plurality of pieces of input data obtained during that period and estimates a model (a first model) that receives the input data as input and outputs output data. This leads to estimation of K models respectively corresponding to the K periods.

In a case where a plurality of models estimated in the past is obtained, the model estimating unit 103 may newly estimate a model only for a period in which no model has been estimated (for example, the latest period). For example, the model estimating unit 103 may estimate a model of the latest period using a plurality of models estimated in the past and stored in the memory unit 121 or the like.

Using the estimated model, the calculating unit 104 calculates an index related to an explanatory variable influencing the output data (objective variable) of the model. For example, the calculating unit 104 calculates the frequency (selection frequency) and the degree of influence (first degree of influence) as indices. The selection frequency indicates a frequency at which a plurality of explanatory variables are selected as variables influencing the output data in the K periods. The degree of influence represents the degree of influence of the plurality of explanatory variables on the output data.

The output control unit 105 controls the output of a variety of information processed by the information processing device 100. For example, the output control unit 105 displays the selection frequency and the degree of influence calculated by the calculating unit 104 on the display 123 in association with each other.

The output control unit 105 can also output information to external devices of the information processing device 100. For example, the output control unit 105 may transmit information for displaying the selection frequency and the degree of influence in association with each other to an external device including a display device.

The constituent elements explained above (the communication control unit 101, the receiving unit 102, the model estimating unit 103, the calculating unit 104, and the output control unit 105) are implemented using one or more hardware processors, for example. For example, the constituent elements explained above can be implemented by making a processor such as a CPU execute a computer program, that is, can be implemented using software. Alternatively, the constituent elements explained above can be implemented using a dedicated processor such as an IC, that is, can be implemented using hardware. Still alternatively, the constituent elements explained above can be implemented using a combination of software and hardware In the case of using a plurality of processors, each processor either can implement one of the constituent elements or can implement two or more constituent elements.

Although the present embodiment presents a case where the model is estimated in the information processing device 100, the model may be estimated in a device outside the information processing device 100. In this case, the information processing device 100 need not include a function (such as the model estimating unit 103) used for model estimation.

The following is the explanation of model estimation processing and visualization processing performed in the information processing device 100 according to the first embodiment configured in this manner. FIG. 2 is a flowchart illustrating an example of the estimation processing and the visualization processing according to the first embodiment.

The receiving unit 102 receives, from the management system 200, a plurality of pieces of input data corresponding to a plurality of periods (Step S101). For each of those periods, the model estimating unit 103 estimates a model using a plurality of pieces of input data obtained during that period (Step S102). Herein, it is assumed that the model estimating unit 103 estimates a regression model for each period.

Using the estimated model, the calculating unit 104 calculates the selection frequency of each of the plurality of explanatory variables and the degree of influence of each of the plurality of explanatory variables (Step S103). The output control unit 105 displays the calculated selection frequency and the degree of influence in association with each other on the display 123, for example (Step S104), and ends the estimation processing and the visualization processing.

Next, details of the estimation processing and the visualization processing will be further described. The following will mainly describe an example of model estimation processing for estimating a model to be applied for quality management in a factory (a semiconductor factory) and a plant (a chemical plant) and visualization processing based on the estimated model.

In a semiconductor factory and a chemical plant, it is required to suppress the variation and the fluctuation of the quality characteristics and to reduce defects, so as to enhance the yield. In order to figure out the factors causing the variation and the fluctuation in the quality characteristics, models such as regression models and classification models are used.

The product undergoes a number of manufacturing steps to become a finished product. In analysis of the variation factor of the quality characteristic of the finished product, the model is estimated using information such as the type of the manufacturing device in each manufacturing process and sensor values detected by the installed sensor as explanatory variables.

In addition, since the manufacturing device deteriorates over time, the trend of the acquired data gradually changes. In addition, operations such as periodic maintenance and part replacement that have a sudden influence on data trends are performed. In view of these, the model is updated in accordance with the change in the data trend.

As described above, in the model of each period of the present embodiment, the objective variable is, for example, information indicating the quality characteristic, the percent defective, the non-defective items/defective items, and the like. The explanatory variables represent other sensor values, setting values, and control values. The dates indicate the manufacturing commencement date, the manufacturing completion date, and the processing dates in specific devices.

The explanatory variables can be subjected to preprocessing in advance. Examples of the preprocessing include standardization, normalization, conversion using specific functions, interaction term addition, time lagging, time reading, dummy parameterization, encoding, outlier processing, and missing-value processing.

Input data including data such as an objective variable and an explanatory variable is stored in the memory unit 221 of the management system 200. The receiving unit 102 receives input of the input data, which is received from the management system 200 via the communication control unit 101.

In the following explanation, n represents the number of pieces of input data (where n is an integer equal to or greater than one); and it is assumed that each piece of data contains the following: p explanatory variables x; a single objective variable y; and a single numerical value t indicating the date. Thus, the i-th piece of input data (xᵢ, yᵢ, tᵢ) (where 1≤i≤n holds true) is expressed using Equation (1) given below.

(xᵢ,yᵢ,tᵢ),xᵢ∈ [symbol] ^{p},yᵢ∈ [symbol] ,tᵢ∈ [symbol] ,i=, . . . , n (1)

Herein, xᵢ represents a p-dimensional vector indicating the explanatory variable; yᵢ represents a scalar indicating the objective variable; and tᵢ represents a scalar indicating the date. As the scalar tᵢ, the length of time (days, hours, minutes, or seconds) counted from a particular starting date can be used. Herein, in order to simplify the notation, it is assumed that 0=t₁≤t₂ . . . ≤tₙ=T holds true. Meanwhile, the date representing the start point can be decided in any manner. Moreover, when the time points are not arranged in order, they can be sorted in advance.

The indices of K periods and K models estimated in the K periods are represented by k=1, . . . , and K in chronological order. A time point at which each model is estimated is tₖ(1<k≤K). The model estimating unit 103 estimates the model in the period k using the input data Dk={(xᵢ, yᵢ, tᵢ)|tₖ₋₁<tᵢ≤tₖ}. For example, in the case of a linear regression model, the model estimating unit 103 estimates the regression model by solving an optimization problem expressed by the following Equation (2) in each period. Herein, β₀ represents a one-dimensional vector, and \hat{ }β^{(k)} represents a p-dimensional vector. The symbol “\hat{ }” represents a hat put on the upper part of the variable written on the right side (in this example, β^{(k)}. Moreover, in β^{T}, “T” represents transposition. With this, K regression models β^{(k)} are estimated.

$${\hat{β}}^{k} = {argmin}_{{β}_{0} , β} {{Σ}_{i ∈ {D}_{k}} ( {y}_{i} - {β}_{0} - {β}^{T} {x}_{i} )}^{2} \qquad ( 2 )$$

The model estimation method is not limited to the method in which the least-square method is used as given earlier in Equation (2). Alternatively, any other method can be implemented. For example, it is also possible to use penalized regression such as Ridge, Lasso, Smoothly Clipped Absolute Derivation (SCAD), Minimax Concave Penalty (MCP), Lq norm (where 0≤q<1 holds true), Elastic Net, or L1/2 norm. It can be interpreted that such penalized regression is a method of estimating a model in such a way that the parameters of the model have sparsity.

Meanwhile, the loss function is not limited to the square error, and any other type of function can be used.

For example, any type of loss function, such as absolute value loss, quantile loss, Huber loss, epsilon sensitivity loss, logistic loss, index loss, hinge loss, or smoothing hinge loss, can be used if applicable in the model estimation method to be implemented.

Alternatively, the model estimating unit 103 can use a loss function that is weighted according to the degree of reliability and the date of each piece of input data.

Meanwhile, the model to be estimated is not limited to a linear regression model, and can alternatively be a polynomial regression model, a logistic regression model, a Poisson regression model, a generalized linear model, a generalized additive model, decision tree, or a neural network model.

The calculating unit 104 can acquire a coefficient matrix \hat{ }β^{(All)} including the regression coefficients (p coefficients) of the models in the entire period (K periods) from the K models estimated as described above. The coefficient matrix \hat{ }β^{(All)} is expressed by, for example, the following Equation (3). In \hat{ }β^{(All)}, zero is set to an element having no information regarding the corresponding regression coefficient due to narrowing of the explanatory variables.

\hat{β}^{(All)}∈ [symbol] ^{K×P} (3)

Hereinafter, β˜ is defined as a standardized regression coefficient, and m=1, . . . , p is defined as an index of an explanatory variable. The calculating unit 104 calculates the standardized regression coefficient β˜ by the following Equation (4), for example. In addition, the calculating unit 104 calculates a degree of influence eₘ and the selection frequency gₘ of the m-th explanatory variable by the following Equations (5) and (6), respectively.

$${\tilde{β}}_{m} = \frac{σ ( {X}_{m} )}{σ ( Y )} \times {\hat{β}}_{m} , {X}_{m} ∈ {ℝ}^{n} , Y ∈ {ℝ}^{n} , σ ( Z ) = \sqrt{\frac{1}{n} {\sum }_{i}^{n} {( {x}_{i} - \overline{z} )}^{2}} ; \overline{z} : mean of z \qquad ( 4 )$$

$$\begin{matrix}{e}_{m} = \frac{\vert {Σ}_{i}^{K} {\tilde{β}}_{m}^{i} \vert}{{Σ}_{j}^{K} 𝕀 ( {\tilde{β}}_{m}^{j} \neq 0 )} , 𝕀 ( x ) = \{ \begin{matrix}1 if x = true \\ 0 if x = false\end{matrix} & ( 5 ) \\ {g}_{m} = \frac{{Σ}_{j}^{K} 𝕀 ( {\tilde{β}}_{m}^{j} \neq 0 )}{K} & ( 6 )\end{matrix}$$

The denominator of Equation (5) and the numerator of Equation (6) correspond to the number of non-zero regression coefficients among the K regression coefficients corresponding to the m-th explanatory variable. When the regression coefficient is non-zero, it can be interpreted that the explanatory variable is selected as a variable influencing the output of the model. Therefore, the value of the denominator of Equation (5) and the value of the numerator of Equation (6) can be interpreted as corresponding to the number of times the m-th explanatory variable has been selected as a variable influencing the output data.

Furthermore, the degree of influence eₘ calculated by Equation (5) can be interpreted as a value corresponding to the mean of the degree of influence (second degree of influence) for each period in which the m-th explanatory variable is selected as a variable to be used for estimation of the regression model. The method of calculating the degree of influence eₘ is not limited to the Equation (5). For example, the calculating unit 104 may calculate the median or the maximum of the value of the numerator of Equation (5) as the degree of influence eₘ. In addition, when identifying the factor by focusing on the latest degree of influence, the calculating unit 104 may calculate a value represented by the following Equation (7) as the degree of influence eₘ.

eₘ=\tilde{β}ₘ^{K} (7)

In addition, the calculating unit 104 may use a value represented by the following Equations (8) or (9) instead of the value of the numerator of formula (5).

Σᵢ^{K}|\tilde{β}ₘⁱ| (8)

Σᵢ^{K}\tilde{β}ₘⁱ (9)

In addition, the calculating unit 104 may use an unstandardized regression coefficient instead of the standardized regression coefficient β˜. The regression coefficient corresponds to information indicating a degree of contribution of the explanatory variable to the regression model. As the information indicating the degree of contribution of the explanatory variable, it is also allowable to use information other than the regression coefficient according to the model to be applied. For example, it is allowable to use the degree of importance obtained by the decision tree or the weight of the neural network.

In addition, the method of calculating the selection frequency gₘ is not limited to Equation (6). For example, the calculating unit 104 may calculate the number of times the m-th explanatory variable is selected, that is, a value corresponding to the numerator of Equation (6), as the selection frequency.

The output control unit 105 displays the calculated degree of influence and the selection frequency in association with each other. For example, the output control unit 105 displays the degree of influence and the selection frequency in association with each other by using a two-dimensional matrix diagram in which the degree of influence is taken on the vertical axis (an example of a first axis) and the selection frequency is taken on the horizontal axis (an example of a second axis).

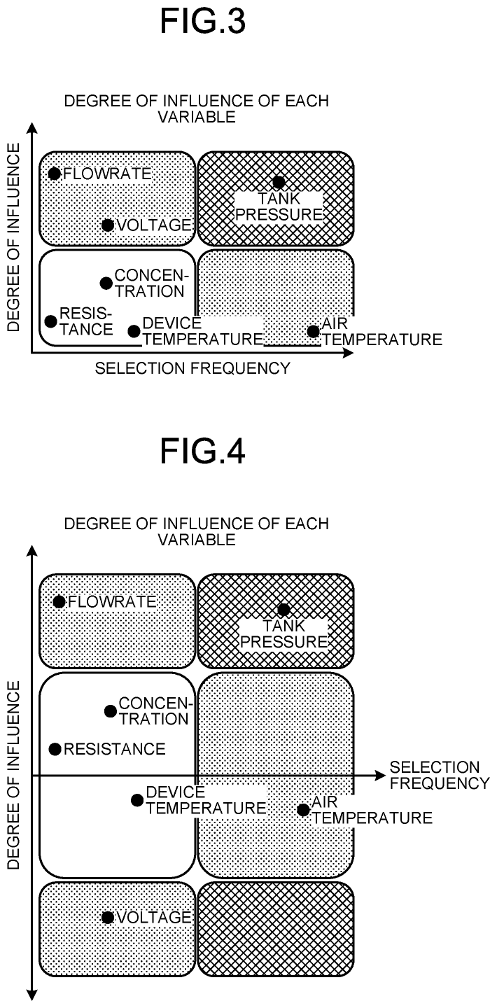

FIG. 3 is a diagram illustrating an example of a matrix diagram to be displayed. FIG. 3 illustrates an example in which filled circles corresponding to seven explanatory variables (flowrate, voltage, tank pressure, concentration, resistance, device temperature, and air temperature) are arranged at positions corresponding to the degree of influence and the selection frequency of each explanatory variable.

FIG. 3 illustrates an example in which a display target region in the matrix diagram is displayed as being divided into four regions (upper right, upper left, lower right, lower left). The four regions of the upper right, the upper left, the lower right, and the lower left correspond to regions where explanatory variables classified into the above (C1), (C2), (C3), and (C4) are arranged, respectively.

In the method of calculating the mean of the degree of influence (M1), a value corresponding to eₘ×gₘ in the present embodiment is calculated as the mean of the degree of influence. Such a method is likely to result in overlooking of a factor having a sudden and great influence on the quality characteristics (an explanatory variable classified in the upper left in the example of FIG. 3).

In contrast, the information processing device 100 according to the present embodiment calculates an index for identifying a factor by dividing the index into the degree of influence eₘ and the selection frequency gₘ, and outputs a matrix diagram illustrating a relationship between the degree of influence and the selection frequency. With this method, for example, it is possible to identify, without fail, a factor having a sudden and great influence on the quality characteristics from the output matrix diagram. This is because a factor influencing the quality characteristic (output data), regardless of whether it is sudden, is explicitly expressed in the degree of influence eₘ.

On the other hand, regardless of the magnitude of the degree of influence, a factor having a high selection frequency is explicitly expressed in the selection frequency gₘ. Therefore, for example, explanatory variables, as in (C3) described above, having a low degree of influence but a high selection frequency (explanatory variables classified in the lower right in the example of FIG. 3) can also be identified without fail.

Note that the method of outputting the degree of influence and the selection frequency is not limited to the matrix diagram as illustrated in FIG. 3. It is also allowable to use, for example, a matrix diagram in which the degree of influence is taken on the horizontal axis and the selection frequency is taken on the vertical axis. In addition, instead of the matrix diagram as illustrated in FIG. 3, other forms of output information such as a graph, a scatter diagram, and a table may be used.

In addition, when the degree of influence can take a negative value as in the case where the value represented by Equation (9) is used for the numerator of Equation (5), the degree of influence may be arranged using axes indicating both the positive direction and the negative direction. FIG. 4 is a diagram illustrating an example of a matrix diagram in such a case.

By using the information displayed as being classified into a plurality of categories in this manner, the user can extract factors influencing the quality characteristics (output data) without fail. Even with a configuration in which periodic model update is performed using the latest data, factors can be extracted and identified without fail by the degree of influence and the selection frequency calculated and displayed using the updated model.

As an example, a flow of identifying a factor of variation in quality characteristics for a device installed outdoors will be described.

In the case of identifying a factor in a state where the operation of the device is stable, it is considered that, for example, the lower right region of FIG. 3 should be preferentially checked. In the case of FIG. 3 in which the air temperature is in the lower right region, the relationship between the air temperature and the variation in quality characteristics is preferentially analyzed. In contrast, when identifying the factor of the sudden stop of the device, it is considered that the upper left region in FIG. 3 should be preferentially checked. In the case of FIG. 3 in which the flowrate and the voltage are in this region, for example, the flowrate control component and the power supply are preferentially analyzed.

Furthermore, according to the present embodiment, for example, analysis can be performed using not only the period of sudden stop but also a model of a plurality of periods (K periods). Therefore, even in the case of a sudden stop in the past, it is possible to integrally analyze the influence in a plurality of periods including the preceding and subsequent periods, leading to achievement of identifying the factor.

### Second Embodiment

The factor of the variation in the quality characteristic can include both a factor having a relatively high degree of urgency for countermeasure and a factor having a relatively low degree of urgency for countermeasure. For example, in the presence of an explanatory variable having a low degree of influence in the past, but having the degree of influence rapidly increasing recently, the degree of urgency is high, requiring preferential countermeasures.

In view of this, an information processing device according to a second embodiment further calculates and outputs information indicating a change in the degree of influence for each explanatory variable in order to indicate a trend of the degree of influence, such as the degree of urgency.

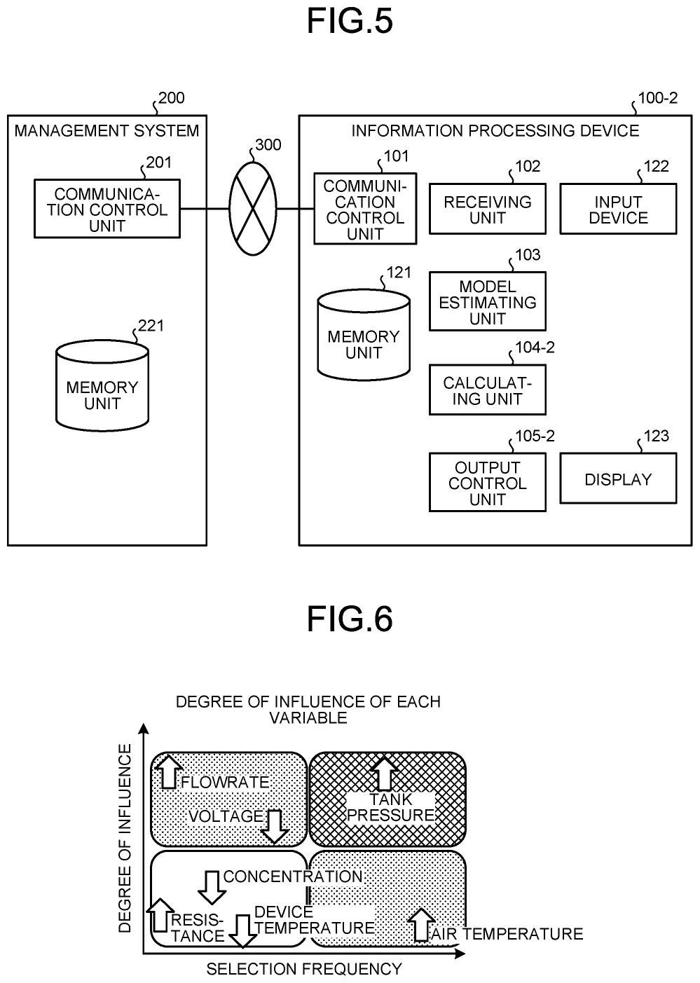

FIG. 5 is a block diagram illustrating an exemplary configuration of an information processing system including an information processing device 100-2 according to the second embodiment. Herein, the management system 200 and the network 300 are identical to the first embodiment. Hence, they are referred to by the same reference numerals, with no duplicated description.

As illustrated in FIG. 5, the information processing device 100-2 includes the memory unit 121, the input device 122, the display 123, the communication control unit 101, the receiving unit 102, a model estimating unit 103, a calculating unit 104-2, and an output control unit 105-2.

In the second embodiment, the calculating unit 104-2 and the output control unit 105-2 are functionally different from the case of the first embodiment. The other constituent elements and the functions are identical to FIG. 1 that is the block diagram of the information processing device 100 according to the first embodiment. Hence, those constituent elements are referred to by the same reference numerals, with no duplicated description.

The calculating unit 104-2 further calculates change information indicating a change in the degree of influence between at least two periods out of the K periods. The two periods are, for example, the latest period K and a period (K−1) immediately before the period K. For example, the calculating unit 104-2 calculates a difference dₘ of the degree of influence between the period K and the immediately preceding period (K−1) for the m-th explanatory variable by the following Equation (10).

dₘ=|\tilde{β}ₘ^{K}|−|\tilde{β}ₘ^{K-1}| (10)

The calculating unit 104-2 may further calculate a result of comparison between the difference dₘ and a threshold (for example, zero). The difference, or the result of comparison between the difference and the threshold, corresponds to the change information.

The output control unit 105-2 further outputs the calculated change information. For example, the output control unit 105-2 visualizes an arrow having a different direction according to the result of comparison between the difference dₘ and the threshold, as a marker. For example, the output control unit 105-2 visualizes an upward arrow when dₘ>0 and a downward arrow when dₘ≤0 as a marker of the explanatory variable. The arrows are examples of change information indicating mutually different directions.

FIG. 6 is a diagram illustrating an example of a matrix diagram including such a marker. As compared with FIG. 3, in which a filled circle corresponding to each explanatory variable is displayed, the example of FIG. 6 displays an arrow as a marker instead of the filled circle.

A method of calculating the change information is not limited to the above Equation (10). For example, in a case where a change in trend is expressed by using the magnitude of the change in the degree of influence over the period K and the period (K−1), the calculating unit 104-2 may calculate the difference dₘ in the degree of influence by the following Equation (11). The sign is calculated by the following Equation (12).

$$\begin{matrix}{d}_{m} = sign ( {\tilde{β}}_{m}^{K} ) ( {\tilde{β}}_{m}^{K} - {\tilde{β}}_{m}^{K - 1} ) & ( 11 ) \\ sign ( β ) = \{ \begin{matrix}+ 1 , ( β > 0 ) \\ 0 , ( β = 0 ) \\ - 1 , ( β < 0 )\end{matrix} & ( 12 )\end{matrix}$$

In this case, similarly to the above, the output control unit 105-2 uses distinctive expressions of markers according to the result of comparison between the difference dₘ and the threshold.

Furthermore, in a case where a value represented by Equation (9) is used as the numerator of the degree of influence eₘ, the calculating unit 104-2 may calculate the difference dₘ of the degree of influence by the following

Equation (13).

dₘ=\tilde{β}ₘ^{K}−\tilde{β}ₘ^{K-1} (13)

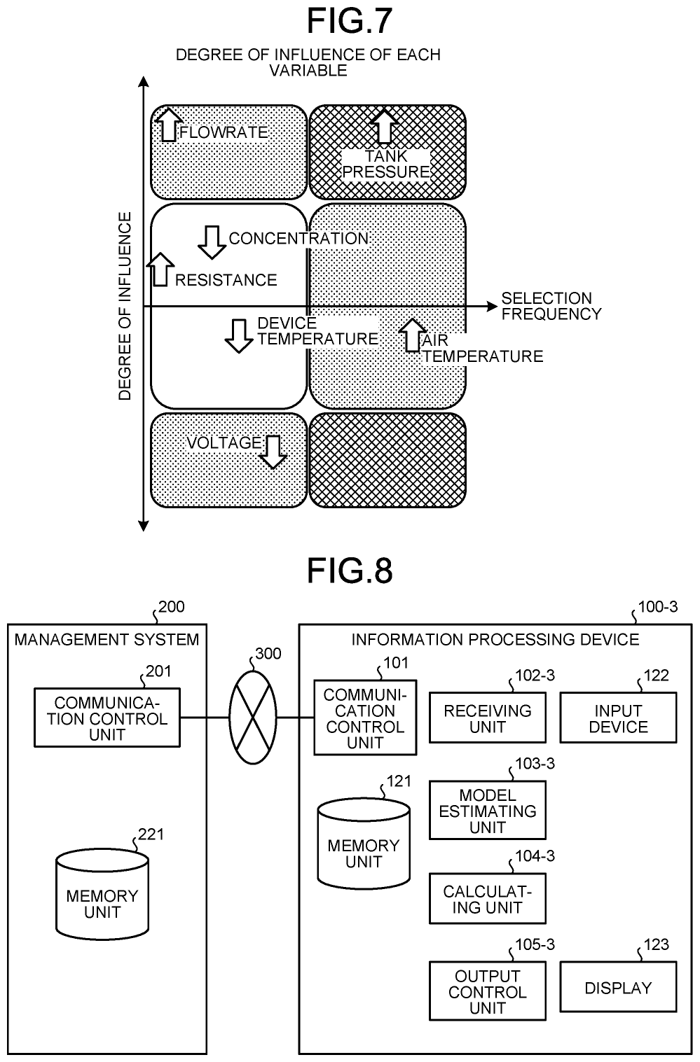

In this case, similarly to the above, the output control unit 105-2 uses distinctive expressions of markers according to the result of comparison between the difference dₘ and the threshold. FIG. 7 is a diagram illustrating an example of a matrix diagram displayed in this case.

The method of outputting the change information (marker) is not limited to the above example. Any method may be used as long as the method outputs change information indicating that the degree of influence has increased and change information indicating that the degree of influence has decreased in mutually different modes.

For example, it is allowable to use a method in which the shape of the marker is fixed to a simple figure other than an arrow, and the trend of increase/decrease in the degree of influence is indicated by color-coding the figure. Note that the method of FIG. 6 is a method in which the color of the marker is fixed and trends are indicated by the direction of an arrow corresponding to the shape of the marker.

In the above example, the threshold to be compared with the difference dₘ is set to zero, but a real number other than zero may be used as the threshold. In addition, the output control unit 105-2 may determine at least one of the color and the length of the arrow according to the magnitude of the difference dₘ.

In addition, the output control unit 105-2 may use, as the change information, which model in the two periods are used to select the m-th explanatory variable, instead of calculating the difference dₘ. For example, the output control unit 105-2 may output change information indicating that the m-th explanatory variable is selected in the L-th (L is an integer satisfying 1≤L<K,) period but is not selected in the (L+1)-th period, and change information indicating that the m-th explanatory variable is not selected in the L-th period but is selected in the (L+1)-th period.

In this manner, the information processing device according to the second embodiment can further output information indicating the change in the degree of influence.

### Third Embodiment

The second embodiment has described that the parameters of the current model and the model in the immediately preceding period are compared, and the trend of the change in the degree of influence is expressed by shapes or colors of markers. The third embodiment will describe an example in which a trend of the degree of influence over a long period of time is output as change information.

FIG. 8 is a block diagram illustrating an example of a configuration of an information processing device 100-3 according to the third embodiment. Herein, the management system 200 and the network 300 are identical to the first embodiment. Hence, they are referred to by the same reference numerals, with no duplicated description.

As illustrated in FIG. 8, the information processing device 100-3 includes the memory unit 121, the input device 122, the display 123, the communication control unit 101, a receiving unit 102-3, a model estimating unit 103-3, a calculating unit 104-3, and an output control unit 105-3.

In the third embodiment, the receiving unit 102-3, the model estimating unit 103-3, the calculating unit 104-3, and the output control unit 105-3 are functionally different from the case of the first embodiment. The other constituent elements and the functions are identical to FIG. 1 that is the block diagram of the information processing device 100 according to the first embodiment. Hence, those constituent elements are referred to by the same reference numerals, with no duplicated description.

The receiving unit 102-3 further receives setting of a period for calculating a long-term trend of the degree of influence and setting of a function used by the model estimating unit 103-3.

The calculating unit 104-3 calculates change information indicating a change in the degree of influence in at least two periods set by the user and received by the receiving unit 102-3, for example, out of the K periods. The period corresponding to the end may be fixed to the latest period K, and only the oldest period corresponding to the start may be set, or two periods corresponding to the start and the end may be set. Hereinafter, a case where only the oldest period is set will be described as an example. For example, the oldest period k is set to satisfy k<K−1. For the setting, either an index of a period (model) or a date may be used.

In a case where the date t is set, the calculating unit 104-3 calculates an index τ of the oldest period (model) by the following Equation (14).

τ=min({k|tₖ≥t}) (14)

The model estimating unit 103-3 estimates a regression model of one variable using the set model of each period. For example, the model estimating unit 103-3 estimates a regression model of one variable from the regression coefficient \hat{ }β^{(k)}ₘ of the model in the period set for each explanatory variable using the coefficient matrix \hat{ }β^{(All)} by the following Equation (15). Note that θ represents a parameter that defines a regression function fₘ.

θₘ=argmin_{θ}ΣΣ_{τ}^{K}(yᵢ−fₘ(\hat{β}ₘ⁽ⁱ⁾)² (15)

Which regression function fₘ is used may be set by the user or the like, and may be received by the receiving unit 102-3. The regression function fₘ is, for example, linear regression, n-th order (>1) approximation, generalized linear regression, exponential function, spline function, Gaussian process regression, or the like.

Equation (15) is an equation estimating a regression function using a square error as a loss function, but the loss function is not limited thereto. For example, any type of loss function, such as absolute value loss, quantile loss, Huber loss, epsilon sensitivity loss, logistic loss, index loss, hinge loss, or smoothing hinge loss, may be used.

The calculating unit 104-3 calculates change information using the regression function estimated in this manner. For example, in a case where linear regression is used as the regression function fₘ, the calculating unit 104-3 calculates the slope of the regression function fₘ as an index indicating an increase or decrease in the degree of influence. In a case where a function that can be differentiated twice, such as n-th order expression approximation, is used as the regression function fₘ, the calculating unit 104-3 calculates the first derivative or the second derivative of the regression coefficient \hat{ }β^{(k)}ₘ as an index indicating an increase or decrease in the degree of influence.

The calculating unit 104-3 may further calculate a result of comparison between the index and a threshold (for example, zero). The index, or the result of comparison between the index and the threshold corresponds to the change information.

The output control unit 105-3 further outputs the calculated change information. For example, the output control unit 105-2 visualizes an arrow having a different direction according to the result of comparison between an index (slope, first order differential, second order differential, and the like) and a threshold as a marker. For example, the output control unit 105-3 visualizes an upward arrow when the index>0 and a downward arrow when the index≤0 as a marker of the explanatory variable.

In this manner, the information processing device according to the third embodiment can output information indicating a change in the degree of influence in a longer period.

### Fourth Embodiment

The first embodiment has described an example of displaying a matrix diagram in which the display target region is divided into four regions. The information processing device according to the fourth embodiment enables adjustment of the division position of the region. For example, the division position of the region is adjusted according to at least one of setting by the user or the like and a history of past countermeasures.

In a case where factor analysis is periodically performed, various explanatory variables emerge as factor candidates each time, and countermeasures are executed for some factors in consideration of priority and the like. In the quality control, a history of executed countermeasures is stored and managed in a database or the like. Therefore, in the present embodiment, for example, the user refers to the past history, determines the values of the degree of influence and the selection frequency corresponding to the position to divide the area, and sets a parameter (region division parameter) for dividing the region. Furthermore, the information processing device according to the present embodiment calculates and sets the region division parameter with reference to the past history.

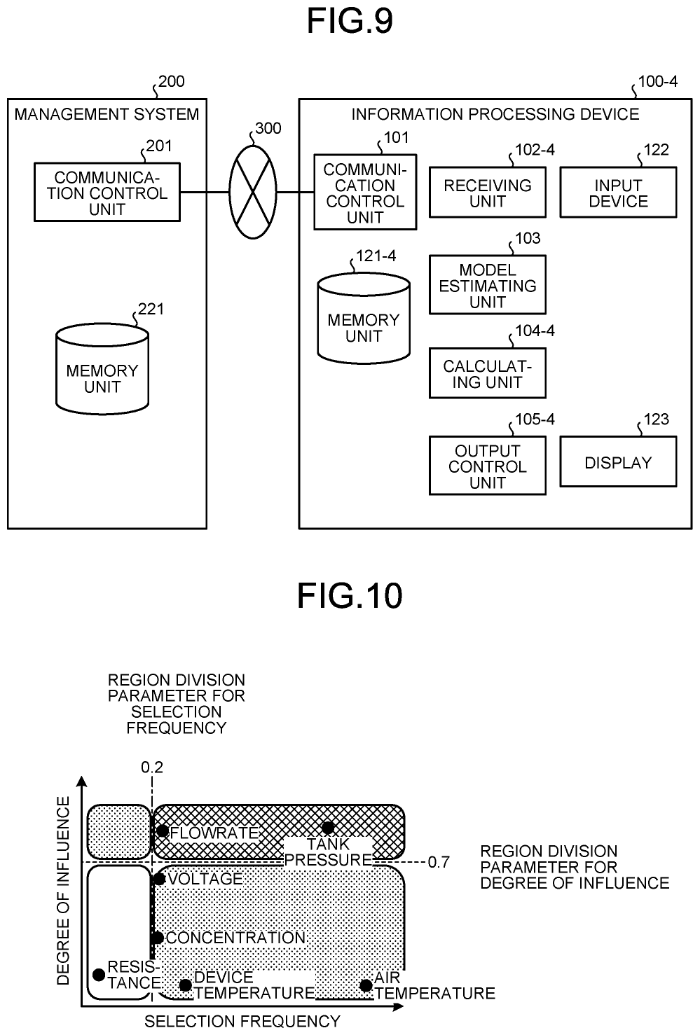

FIG. 9 is a block diagram illustrating an example of a configuration of an information processing device 100-4 according to the fourth embodiment. Herein, the management system 200 and the network 300 are identical to the first embodiment. Hence, they are referred to by the same reference numerals, with no duplicated description.

As illustrated in FIG. 9, the information processing device 100-4 includes a memory unit 121-4, the input device 122, the display 123, the communication control unit 101, a receiving unit 102-4, a model estimating unit 103, a calculating unit 104-4, and an output control unit 105-4.

In the fourth embodiment, the memory unit 121-4, the receiving unit 102-4, the calculating unit 104-4, and the output control unit 105-4 are functionally different from the case of the first embodiment. The other constituent elements and the functions are identical to FIG. 1 that is the block diagram of the information processing device 100 according to the first embodiment. Hence, those constituent elements are referred to by the same reference numerals, with no duplicated description.

The memory unit 121-4 further stores information regarding a history of countermeasures acquired from the management system 200, for example. The history of the countermeasure includes, for example, an explanatory variable as a target of a countermeasure for suppressing variations in quality characteristics, and values of the degree of influence and selection frequency calculated for the explanatory variable at implementation of the countermeasure. The history of the countermeasure may further include information indicating a period or date of the implementation of the countermeasure.

The receiving unit 102-4 further receives the setting of the region division parameter designated by the user or the like. The region division parameter is, for example, a reference value (first reference value) indicating the division position of the degree of influence and a reference value (second reference value) indicating the division position of the selection frequency. The setting method may be any method, and it is possible to use, for example, a method of setting each reference value by slide bars provided in the directions of the vertical axis and the horizontal axis of the matrix diagram.

The information processing device 100-4 may be configured to calculate the region division parameter with reference to the history of the countermeasure instead of the setting by the user or together with the setting by the user. The calculating unit 104-4 further includes a function for such a configuration. That is, the calculating unit 104-4 further includes a function of calculating the region division parameter with reference to the history of the countermeasure.

For example, the calculating unit 104-4 reads the degree of influence and the selection frequency included in the history regarding the explanatory variable to be an analysis target from the memory unit 121-4, and calculates the mean of the read degree of influence and the mean of the selection frequency as region division parameters (first reference value, second reference value). Instead of the mean, the calculating unit 104-4 may calculate a median, a maximum, a minimum, a quantile, and the like as the region division parameters. The calculating unit 104-4 may calculate a reference value of only one of the degree of influence and the selection frequency.

In a case where the history includes information indicating a date or period of execution of the countermeasure, the calculating unit 104-4 may read a history of the countermeasure within a period as analysis target with reference to the information.

The output control unit 105-4 outputs a matrix diagram obtained by dividing the region according to the region division parameter set by the user or calculated by the calculating unit 104-4.

FIG. 10 is a diagram illustrating an example of a matrix diagram displayed in the present embodiment. FIG. 10 illustrates an example in which 0.7 is set as the region division parameter of the degree of influence and 0.2 is set as the region division parameter of the selection frequency.

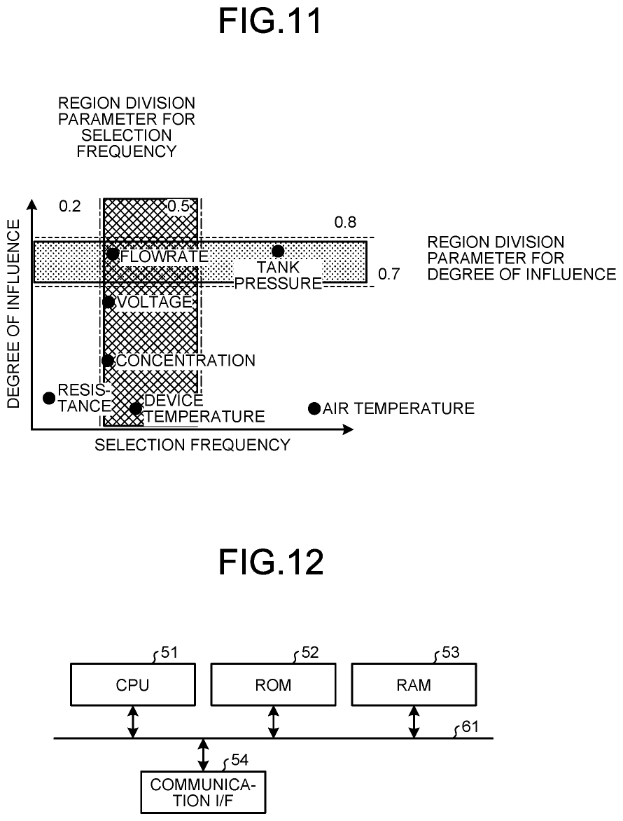

Two values of a maximum and a minimum may be used as the region division parameter. FIG. 11 is a diagram illustrating an example of a matrix diagram in such a case. By dividing the area by the two values of the maximum and the minimum, it is possible to indicate a region where countermeasures have been taken in the past (region between the maximum and the minimum).

In this manner, in the fourth embodiment, the division position of the display target region can be adjusted according to the history of the past countermeasures and the like.

As described above, according to the first to fourth embodiments, it is possible to more easily identify the influence of the plurality of variables on the output.

Next, a hardware configuration of the information processing devices according to the first to fourth embodiments will be described with reference to FIG. 12. FIG. 12 is an explanatory diagram illustrating an exemplary hardware configuration of the information processing devices according to the first to fourth embodiments.

Each of the information processing devices according to the first to fourth embodiments includes a control device such as a CPU 51; memory devices such as read only memory (ROM) 52 and RAM 53; a communication interface (I/F) 54 that establishes connection with a network and performs communication; and a bus 61 that connects the constituent elements to each other.

A computer program executed in each of the information processing devices according to the first to fourth embodiments is stored in advance in the ROM 52.

Alternatively, the computer program executed in each of the information processing devices according to the first to fourth embodiments can be recorded as an installable file or an executable file in a computer-readable recording medium such as a compact disk read only memory (CD-ROM), a flexible disk (FD), a compact disk recordable (CD-R), or a digital versatile disk (DVD); and can be provided as a computer program product.

Still alternatively, the computer program executed in each of the information processing devices according to the first to fourth embodiments can be stored in a downloadable manner in a computer connected to a network such as the Internet. Still alternatively, the computer program executed in each of the information processing devices according to the first to fourth embodiments can be distributed via a network such as the Internet.

The computer program executed in each of the information processing devices according to the first to fourth embodiments can make a computer function as the constituent elements of that information processing device. In that computer, the CPU 51 can read the computer program from a computer-readable memory medium into the main memory device, and can execute the computer program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising:
one or more processors configured to:
calculate a first degree of influence of a plurality of variables on output data, and a frequency at which the plurality of variables are selected as a variable influencing the output data, based on K first models, the K first models being models estimated using a plurality of pieces of input data including the plurality of variables, the plurality of input data being obtained in K periods, K being an integer of 2 or more, the first model receiving input of the input data including the plurality of variables and outputting the output data; and
output the first degree of influence and the frequency in association with each other.

2. The device according to claim 1,
wherein the one or more processors calculate the first degree of influence being one of a mean, a median, and a maximum of a second degree of influence of a plurality of variables on the output data in each of one or more periods in which the plurality of variables have been selected as the variable influencing the output data, among the K periods.

3. The device according to claim 1,
wherein the one or more processors output a matrix diagram in which the first degree of influence is taken on a first axis and the frequency is taken on a second axis.

4. The device according to claim 3,
wherein the one or more processors output the matrix diagram including a plurality of regions divided by a first reference value of the first degree of influence and a second reference value of the frequency.

5. The device according to claim 4,
wherein the one or more processors calculate at least one of the first reference value or the second reference value based on a history of processing executed for a variable selected as the variable influencing the output data among the plurality of variables.

6. The device according to claim 1,
wherein the one or more processors further output change information indicating a change in the first degree of influence between at least two periods of the K periods.

7. The device according to claim 6,
wherein the one or more processors output the change information indicating that the first degree of influence has increased and the change information indicating that the first degree of influence has decreased, in mutually different modes.

8. The device according to claim 7,
wherein the one or more processors output the change information indicating that the first degree of influence has increased and the change information indicating that the first degree of influence has decreased, as pieces of information indicating mutually different directions.

9. The device according to claim 7,
wherein the one or more processors output the change information indicating that the first degree of influence has increased and the change information indicating that the first degree of influence has decreased, in mutually different colors.

10. The device according to claim 1,
wherein the one or more processors output information indicating that any of the plurality of variables is selected in an L-th period, L being an integer satisfying 1≤L<K, but is not selected in an (L+1)-th period, and information indicating that any of the plurality of variables is not selected in the L-th period but is selected in the (L+1)-th period.

11. An information processing method implemented in an information processing device, the method comprising:
calculating a first degree of influence of a plurality of variables on output data, and a frequency at which the plurality of variables are selected as a variable influencing the output data, based on K first models, the K first models being models estimated using a plurality of pieces of input data including the plurality of variables, the plurality of input data being obtained in K (K is an integer of 2 or more) periods, the first model receiving input of the input data including the plurality of variables and outputting the output data; and
performing output control of outputting the first degree of influence and the frequency in association with each other.

12. A computer program product comprising a non-transitory computer-readable medium including programmed instructions, the instructions causing a computer to execute:
calculating a first degree of influence of a plurality of variables on output data, and a frequency at which the plurality of variables are selected as a variable influencing the output data, based on K first models, the K first models being models estimated using a plurality of pieces of input data including the plurality of variables, the plurality of input data being obtained in K (K is an integer of 2 or more) periods, the first model receiving input of the input data including the plurality of variables and outputting the output data; and
performing output control of outputting the first degree of influence and the frequency in association with each other.
